(19) United States
(12) Patent Application Publication
(10) Pub. No.: US 2009/0271861 A1
(43) Pub. Date: Oct. 29, 2009

(54) Data processing apparatus and access control method therefor

(75) Inventor: Makoto Yoshida, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/285,078

(22) Filed: Sep. 29, 2008

(30) Foreign Application Priority Data
Apr. 28, 2008 (JP) 2008-117080

(51) Int. Cl. G06F 21/00

(52) U.S. Cl. 726/17

(57) ABSTRACT

A data processing apparatus according to the present invention includes: peripheral devices each including a plurality of registers each storing a preset value or data; a processing unit to output access authority information indicative of a first access authority level or a second access authority level, which is an access authority level lower than the first access authority level, according to a program to be executed, and to output an access address to specify a specific register; and a peripheral device protection circuit connected to the processing unit and receiving the access authority information and the access address so as to control access of the processing unit to the peripheral devices. The peripheral device protection circuit controls whether to permit the access to the specific register specified by the access address, based on the access authority level indicated by the access authority information.

### BACKGROUND OF THE INVENTION

1. Field of the Invention

The present invention relates to a data processing apparatus and an access control method therefor. In particular, the present invention relates to a data processing apparatus to control access of a processing unit to registers of peripheral devices for each program to be executed by the processing unit, and an access control method for the data processing apparatus.

2. Description of Related Art

Data processing apparatuses including a processing unit to execute a program and peripheral devices accessed by the processing unit may restrict access to the peripheral devices, which can be accessed by the processing unit, for each program to be executed. By restricting the access to each of the peripheral devices, the peripheral device used by a program being executed is prevented from being accessed by another program that performs an unauthorized operation, for example.

An example of the data processing apparatuses to perform such access control is disclosed in Japanese Patent Translation Publication No. 2006-523347. FIG. 11 shows a block diagram of a data processing apparatus 100 disclosed in Japanese Patent Translation Publication No. 2006-523347. In the data processing apparatus 100, access of each of bus masters 114 and 115 and a bus slave 126 to peripheral devices 122 and 124 is restricted by a data processing system in which the bus masters 114 and 115 and the bus slave 126 are connected to the peripheral devices 122 and 124 via buses 116 and 120. In the data processing apparatus 100, a trusted bus master dynamically updates the authority and reliability attribute of the bus masters 114 and 115, and the access control for the peripheral devices, thereby improving the reliability of the access to the peripheral devices in the data processing system. Note that the data processing apparatus 100 includes a bus interface 118 connecting the system bus 116 to the peripheral device bus 120, and a bus arbitration logic 128 to arbitrate a timing of data transfer through the system bus 116. Further, the peripheral device 122 includes a peripheral device circuit 119 to realize a function of the peripheral device 122, and a peripheral device register 121 to store various data used by the peripheral device circuit 119. The peripheral device 124 includes a peripheral device circuit 123 to realize a function of the peripheral device 124, and a peripheral device register 125 to store various data used by the peripheral device circuit 123.

In the data processing apparatus 100, however, protection setting is made only for each peripheral device. Accordingly, if the peripheral device includes a register, which is low in level of importance and is permitted to be accessed by an untrusted program, and also includes a register, which is high in level of importance and is not permitted to be accessed by an untrusted program, there arises a problem of a decrease in operation speed of the data processing apparatus 100.

To explain the above problem, FIG. 12 shows a timing diagram of an accessing operation to the peripheral devices in the above-mentioned case. In the case of the protection setting for each peripheral device, protection setting for restricting the access from the untrusted program is generally applied to the peripheral devices including at least one register that is high in level of importance. Accordingly, as shown in FIG. 12, when the register which is low in level of importance and to which the protection setting is applied is accessed by the untrusted program, it is necessary to perform switching between programs to be executed from the untrusted program to the trusted program. After that, the register that is low in level of importance is to be accessed by the trusted program.

In view of the foregoing, in the case of protection setting for each peripheral device, the switching between programs may be frequently performed during execution of access to the peripheral devices. This leads to a problem of a decrease in operation speed of the data processing apparatus.

### SUMMARY

In one embodiment of the present invention, there is provided a data processing apparatus including: peripheral devices each including a plurality of registers each storing a preset value or data; a processing unit to output access authority information indicative of one of a first access authority level and a second access authority level, which is an access authority level lower than the first access authority level, according to a program to be executed, and to output an access address to specify a specific register among the plurality of registers; and a peripheral device protection circuit connected to the processing unit and receiving the access authority information and the access address so as to control access of the processing unit to the peripheral devices. In the data processing apparatus, the peripheral device protection circuit controls whether to permit the access to the specific register specified by the access address, based on the access authority level indicated by the access authority information.

In another embodiment of the present invention, there is provided an access control method for a data processing apparatus, the data processing apparatus including: peripheral devices each including a plurality of registers each having a preset value or data; a processing unit to output access authority information indicative of one of a first access authority level and a second access authority level, which is an access authority level lower than the first access authority level, according to a program to be executed, and to output an access address to specify a specific register among the plurality of registers; and a peripheral device protection circuit connected to the processing unit and receiving the access authority information and the access address so as to control access of the processing unit to the peripheral devices, the method including: determining whether to permit access to the specific register specified by the access address, based on the access authority level indicated by the access authority information; and controlling the access to the specific register based on a result of the determination.

The data processing apparatus and the access control method therefor are capable of setting the access authority level for permitting access, for each register specified by the access address. Accordingly, in the case of accessing the peripheral device including a plurality of registers with different access authority levels for permitting access, the access to a single peripheral device can be executed without changing the access authority level by switching programs to be executed.

The data processing apparatus and the access control method therefor according to the present invention enable access to a peripheral device including registers, to which protection setting is applied, at high speed while securing the reliability of the access.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a data processing apparatus according to a first embodiment of the present invention;

FIG. 2 is a block diagram showing a peripheral device protection circuit according to the first embodiment;

FIG. 3 is a timing diagram showing an operation of the data processing apparatus according to the first embodiment;

FIG. 4 is a block diagram showing a data processing apparatus according to a second embodiment of the present invention;

FIG. 5 is a block diagram showing a peripheral device protection circuit according to the second embodiment;

FIG. 6 is a conceptual diagram showing an operation of the peripheral device protection circuit according to the second embodiment;

FIG. 7 is a flowchart showing an operation of the data processing apparatus according to the second embodiment;

FIG. 8 is a block diagram showing a data processing apparatus according to a third embodiment of the present invention;

FIG. 9 is a block diagram showing a peripheral device protection circuit according to the third embodiment;

FIG. 10 is a block diagram showing a data processing apparatus according to a fourth embodiment of the present invention;

FIG. 11 is a block diagram showing a data processing apparatus of a related art; and

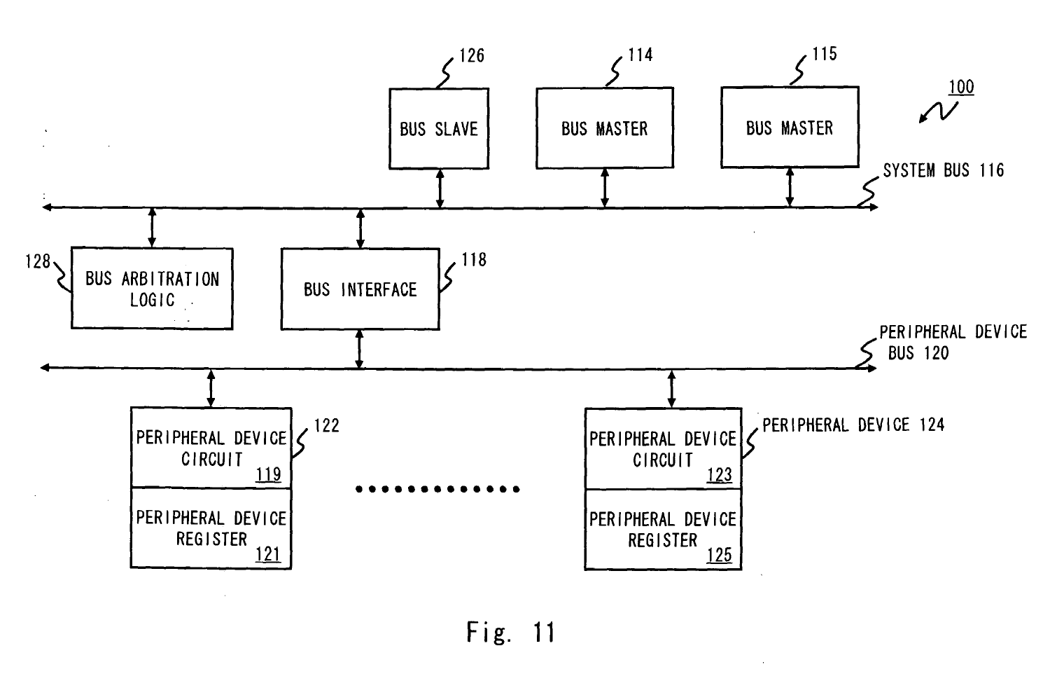

FIG. 12 is a timing diagram showing an operation of the data processing apparatus of the related art.

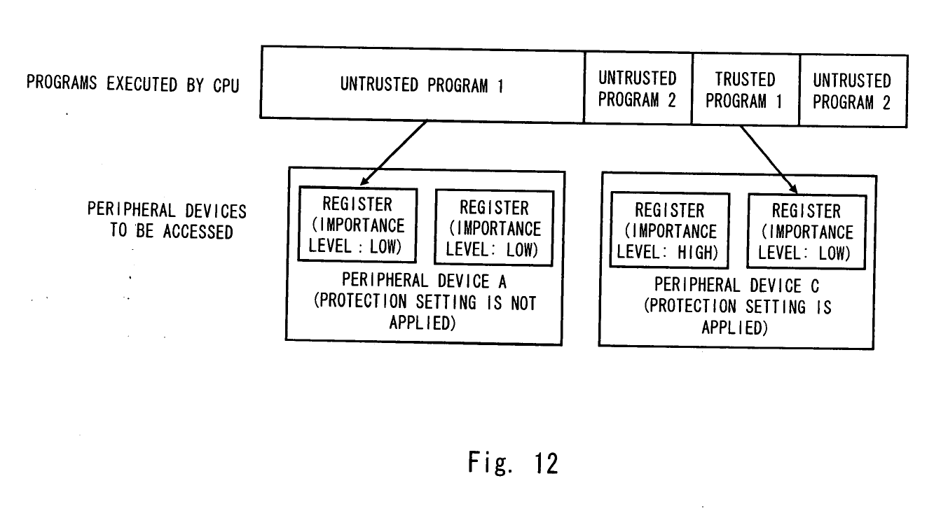

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

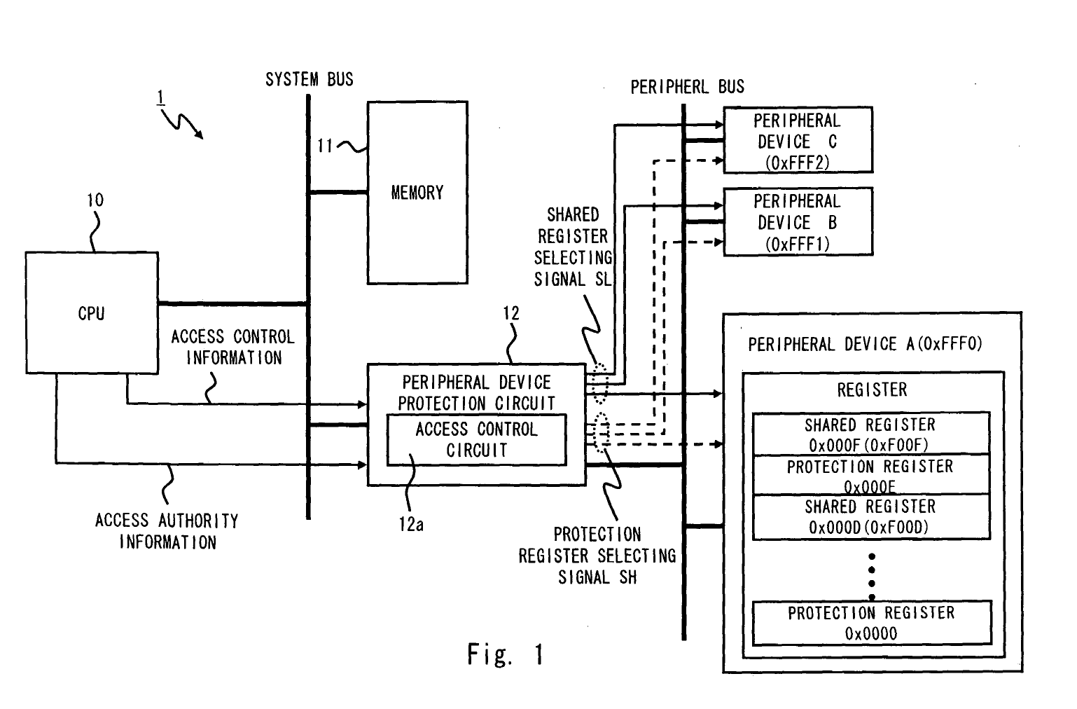

Hereinafter, embodiments of the present invention will be described with reference to the attached drawings. FIG. 1 shows a block diagram of a data processing apparatus 1 according to a first embodiment of the present invention. Referring to FIG. 1, the data processing apparatus 1 includes a processing unit (for example, CPU: Central Processing Unit) 10, a storage device (for example, memory) 11, a peripheral device protection circuit 12, peripheral devices A to C, a system bus, and a peripheral bus. The CPU 10 is connected to each of the memory 11 and the peripheral device protection circuit 12 via the system bus. The CPU 10 is further connected to the peripheral bus via the peripheral device protection circuit 12. The peripheral is connected to each of the peripheral devices A to C. Though FIG. 1 shows three peripheral devices, more peripheral devices may be connected to the peripheral bus.

The CPU 10 is a processing unit to execute a program. Further, the CPU 10 outputs access control information, access authority information, and access information depending on the program to be executed. The access authority information is indicative of an access authority level set for each program to be executed. The access control information specifies permission or denial of access of the peripheral devices to registers of the peripheral devices at each access authority level. The access authority level indicates authority of the CPU 10 to access the registers of the peripheral devices, that is, indicates a range of the registers of the peripheral devices which can be accessed by the CPU 10. The access information is output to the system bus. The access information includes access addresses including an address of each peripheral device to be accessed and an address of each register provided in the peripheral devices, peripheral access information indicative of the type of access such as a read access or a write access, and other access information associated with transmitted and received data and the like.

Note that the access authority levels include a first access authority level and a second access authority level that is an access authority level lower than the first access authority level. Hereinafter, the first access authority level is referred to as an OS level, and the second access authority level is referred to as a user level. The OS level is output in a state where an operating system (OS) is executed by the CPU 100, for example. Further, the user level is output in a state where a user application is executed by the CPU 10. It is assumed that an operating state of a user program is managed by the OS. In the first embodiment, a description is given of a case where the CPU 10 outputs two access authority levels, but the CPU 10 may operate at three or more access authority levels. In this case, among the plurality of access authority levels, a high-order access authority level is referred to as the first access authority level, and a low-order access authority level is referred to as the second access authority level.

Further, the access control information contains a first protection preset value and a second protection preset value. The first protection preset value contains a preset value for specifying permission or denial of access of the CPU 10 to the registers of the peripheral devices at the first access authority level. The second protection preset value contains a preset value for specifying permission or denial of access of the CPU 10 to the registers of the peripheral devices at the second access authority level. Though the CPU 10 outputs the access control information to set the first protection preset value and the second protection preset value in the first embodiment, the first protection preset value and the second protection preset value can also be set without using the access control information. For example, the first protection preset value and the second protection preset value can be set in advance as fixed values, or the access control information can be output from devices other than the CPU 10.

Furthermore, the CPU 10 has ranges of access addresses that can be output at each access authority level. The CPU 10 includes access addresses each of which corresponds to a single register of the peripheral devices in each access address range. For example, an access address corresponding to a register having a physical address of 0x000F is defined as 0x000F in a first address range corresponding to the OS level, and the access address is defined as 0xF00F in a second address range corresponding to the user level.

The memory 11 is used as a storage area storing a program to be executed by the CPU 10, and is also used as a storage area temporarily storing data generated during processing of the program executed by the CPU 10.

The peripheral device protection circuit 12 controls whether the access information, which is to be sent from the CPU 10 to each of the peripheral devices A to C, is transmitted to each of the peripheral devices A to C, based on the access control information, the access information, and the access authority information. More specifically, upon receiving the access control information, the access information, and the access authority information, when the register specified by the access address contained in the access information is permitted to be accessed at the access authority level indicated by the access authority information, the peripheral device protection circuit 12 outputs a selection signal to any one of the peripheral devices A to C. Details of the peripheral device protection circuit 12 will be described later. The selection signal indicates validity or invalidity of the access from the CPU 10 to the peripheral device. The peripheral device enables the access from the CPU 10 when the selection signal indicates validity, and disables the access from the CPU 10 when the selection signal indicates invalidity.

The peripheral devices A to C implement various functions accessed by the CPU 10. The peripheral devices A to C each include a plurality of registers. In the first embodiment, the CPU 10 accesses those registers. Further, the peripheral devices A to C have device addresses 0xFFF0 to 0xFFF2, respectively, for specifying the devices. The CPU 10 accesses the specific peripheral device by setting the device address in the range of the access addresses. As a method of selecting the peripheral device, not only the selection method using the device addresses but also a method using a chip select signal or the like can be employed. Thus, an appropriate selection method can be used depending on the system.

In this case, the registers provided in the peripheral device will be described by way of an example of the peripheral device A. For example, the peripheral device A includes 16 registers having physical addresses represented by 0x0000 to 0x000F, respectively. Registers having physical addresses 0x000D and 0x000F, respectively, are defined as shared registers that are permitted to be accessed at both the OS level and the user level. Meanwhile, registers having physical addresses 0x0000 to 0x000C and 0x000E, respectively, are defined as protection registers that are permitted to be accessed only when the access authority level indicates the OS level. In this case, the CPU 10 can access not only the shared registers having the access addresses 0x000D and 0x000F, respectively, but also shared registers having access addresses F00D and F00F, respectively, which are contained in the second access range.

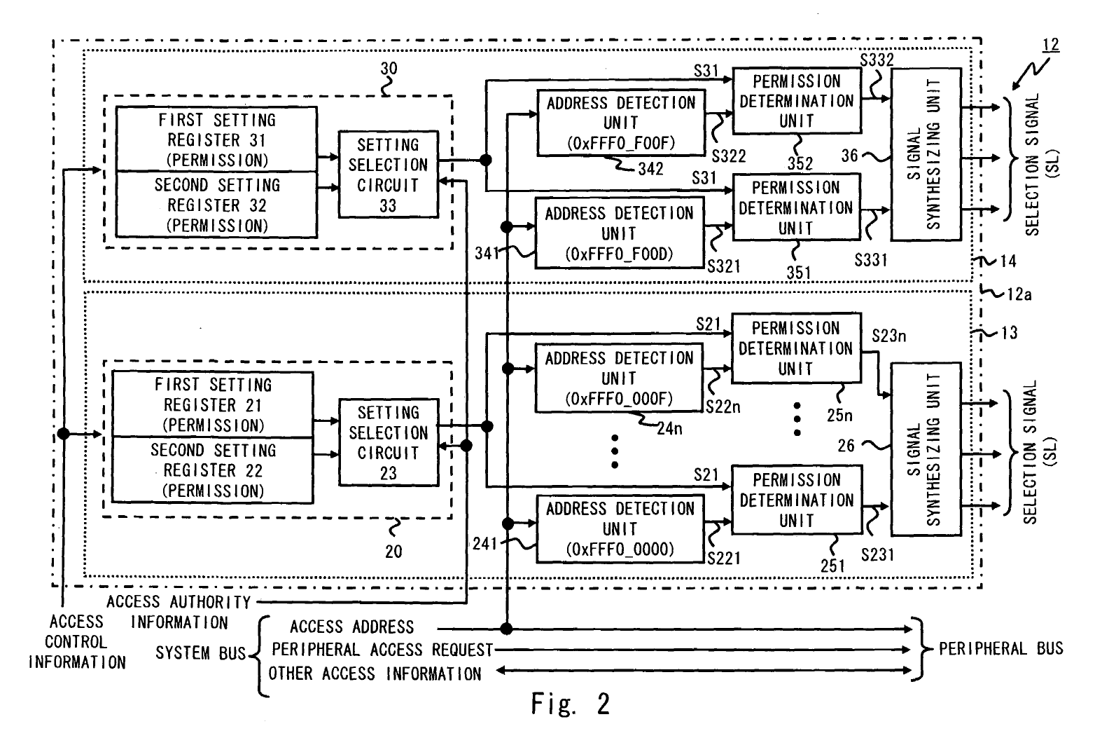

Next, the peripheral device protection circuit 12 will be described in detail below. FIG. 2 shows a block diagram of the peripheral device protection circuit 12. Referring to FIG. 2, the peripheral device protection circuit 12 includes an access control circuit 12a and a signal path connecting the system bus and the peripheral bus to each other. The signal path carries the access address, a peripheral access request, and other access information, which are output by the CPU 10, from the system bus side to the peripheral bus side.

The access control circuit 12a includes a first access determination unit 13 and a second access determination unit 14. The first access determination unit 13 outputs a first enable signal (for example, protection register selecting signal SH) (or shows that access is enabled) in the case where the access address, which is input when the access authority information indicates the OS level, shows the address of the register permitted to be accessed at the OS level. The second access determination unit 14 outputs a second enable signal (for example, shared register selecting signal SL) (or shows that access is enabled) in the case where the access address, which is input when the access authority information indicates the user level, shows the address of the register permitted to be accessed at the user level.

The first access determination unit 13 includes a first access authority detection unit 20, first address detection units 24l to 24n, first permission determination units 25l to 25n, and a first signal synthesizing unit 26. The first access authority detection unit 20 outputs a permission determination signal enabled when the access authority level indicates the OS level. The first access authority detection unit 20 includes a first setting register 21, a second setting register 22, and a setting selection circuit 23.

The first setting register 21 stores a preset value indicative of permission or denial of the access at the OS level. The second setting register 22 stores a preset value indicative of permission or denial of the access at the user level. The preset values stored in the first setting register 21 and the second setting register 22 are given by the access control information output by the CPU 10 that executes a program (for example, management program) with an authority level higher than the, OS level before starting an operation of a program of the OS level. In the first embodiment, the first setting register 21 and the second setting register 22 are provided for registers having access addresses of 0xFFF0_{—}000 to 0xFFF0_{—}000F, respectively, which are permitted to be accessed at the OS level. Accordingly, a preset value as “permission” is given to the first setting register 21, and a preset value as “denial” is given to the second setting register 22. The setting selection circuit 23 refers to the values of the first setting register 21 and the second setting register 22, and outputs a permission determination signal S21 when the access authority level indicated by the input access authority information is equal to or higher than the access authority level determined as permission by the preset value. In the first embodiment, when the access authority information indicates the OS level, the setting selection circuit 23 outputs the permission determination signal S21, and notifies a post-stage circuit of occurrence of access from the program of the OS level.

The first address detection units 24l to 24n are provided in proportion to the number of the protection registers permitted to be accessed at the OS level. According to the first embodiment, in the case of the access at the OS level, setting is performed such that all the registers are permitted to be accessed. Accordingly, the number of the first address detection units is equal to the total number of the registers of the peripheral devices A to C. Note that FIG. 2 shows only the first address detection units 24l to 24n corresponding to the peripheral device A. The first address detection units 24l to 24n hold the addresses of the protection registers, respectively. When the input access address matches the address held in the first address detection unit, the first address detection units 24l to 24n each output a match result signal. Note that FIG. 2 shows match result signals S221 to S22n corresponding to the first address detection units 24l to 24n, respectively.

The first permission determination units are provided to correspond to the first address detection units. Further, the first permission determination units are each notified of the access authority information indicating the OS level by the permission determination signal S21 from the first access authority detection unit 20. When the access address matching the address held by the first address detection unit is detected in the corresponding first address detection unit, the first permission determination unit outputs the first enable signal. The example illustrated in FIG. 2 shows the first permission determination units 25l to 25n provided to correspond to the first address detection units 24l to 24n, respectively. Further, the first enable signals corresponding to the first determination units 25l to 25n are denoted by S231 to 23n, respectively.

The first signal synthesizing unit 26 enables the first selection signal SH for the peripheral device corresponding to the access address input when any one of the first enable signals S23l to S23n indicates a permission state. The first selection signal SH indicates the validity of invalidity of the access to the register to be permitted at the OS level. When the first selection signal SH is in the enabled state, the peripheral device recognizes that the access to the register to be permitted at the OS level is valid among the registers of the peripheral device, and allows the register to be accessed by the CPU 10. Meanwhile, when the first selection signal SH is in the disabled state, the peripheral device recognizes that the access to the register to be permitted at the OS level is invalid among the registers of the peripheral device, and disables the access from the CPU 10.

The second access determination unit 14 includes a second access authority detection unit 30, second address detection units 341 and 342, second permission determination unit 351 and 352, and a second signal synthesizing unit 36. The second access authority detection unit 30 outputs a permission determination signal enabled when the access authority level indicates the user level. The second access authority detection unit 30 includes a first setting register 31, a second setting register 32, and a setting selection circuit 33.

The first setting register 31 stores a preset value indicative of permission or denial of the access at the OS level. The second setting register 32 stores a preset value indicative of permission or denial of the access at the user level. The preset values stored in the first setting register 31 and the second setting register 32 are given by the access control information output by the CPU 10 that executes a program with an authority level higher than the OS level before starting an operation of a program of the OS level. In the first embodiment, the first setting register 31 and the second setting register 32 are provided for shared registers having access addresses of 0xFFF0_F00D to 0xFFF0_F00F, respectively, which are permitted to be accessed at the user level. Accordingly, the preset value as “permission” is given to both the first setting register 31 and the second setting register 32. The setting selection circuit 33 refers to the values of the first setting register 31 and the second setting register 32. When the access authority level indicated by the input access authority information is equal to or higher than the access authority level determined as permission by the preset value, the setting selection circuit 33 outputs a permission determination signal S31. According to the first embodiment, in any case of the user level and the OS level indicated by the access authority information, the setting selection circuit 33 outputs the permission determination signal S31, and notifies a post-stage circuit of occurrence of access from the program of the user level or the OS level.

In the first embodiment, when access is made at a low access authority level in the case where the preset value of the first setting register 31 corresponding to the high protection level indicates denial and the preset value of the second setting register 32 corresponding to the low protection level indicates permission, the setting selection circuit 33 sets the permission determination signal S31 to indicate a denial state for the access at the low access authority level irrespective of the value of the second setting register 32. Execution of such an operation by the setting selection circuit 33 enables improvement of the reliability lowered when the value stored in the setting register is destroyed.

The second address detection units 341 and 342 are provided in proportion to the number of the shared registers permitted to be accessed at the user level. According to the first embodiment, in the case of the access at the user level, setting is performed such that the shared registers (of only peripheral device A) having access addresses 0xFFF0_F00D and 0xFFF0_F00F, respectively, are permitted to be accessed. Accordingly, the number of the second address detection units is equal to the total number of the shared registers of the peripheral device A. Note that FIG. 2 shows only the second address detection units 341 and 342 corresponding to the peripheral device A. The second address detection units 341 and 342 hold the addresses of the protection registers, respectively. When the input access address matches the address held in each of the second address detection units 341 and 342, the second address detection units 341 and 342 each output the match result signal. Note that FIG. 2 shows match result signals S321 and S322 corresponding to the second address detection units 341 and 342, respectively.

The second permission determination units are provided to correspond to the second address detection units. The second permission determination units are each notified of the access authority information indicating the user level or the OS level by the permission determination signal S31 from the second access authority detection unit 30. When the access address matching the address held by the second address detection unit is detected in the corresponding second address detection unit, the second permission determination unit outputs the second enable signal. The example illustrated in FIG. 2 shows the second permission determination units 351 and 352 provided to correspond to the second address detection units 341 and 342, respectively. Further, second enable signals corresponding to the second permission determination units 351 and 352 are denoted by S331 and S332, respectively.

The second signal synthesizing unit 36 enables the second selection signal SL for the peripheral device corresponding to the access address input when one of the second enable signals S331 and S332 indicates the permission state. The second selection signal SL indicates an enabled or disabled state of the access to the register to be permitted to be accessed at the user level. When the second selection signal SL is in the enabled state, the peripheral device recognizes that the access to the shared register to be permitted at the user level among the registers of the peripheral device is valid, and allows the shared register to be accessed by the CPU 10. Meanwhile, when the second selection signal SL is in the disabled state, the peripheral device recognizes that the access to the shared register to be permitted at the user level among the registers of the peripheral device is invalid, and disables the access from the CPU 10.

Note that, in the first embodiment, the accesses address for the shared registers are different from the physical addresses of the registers of each peripheral device. Accordingly, the peripheral device decodes the access addresses each output by the CPU 10 to calculate the physical address corresponding to each of the access addresses. Then, each peripheral device allows the shared register, which is specified by the calculated physical address, to be accessed.

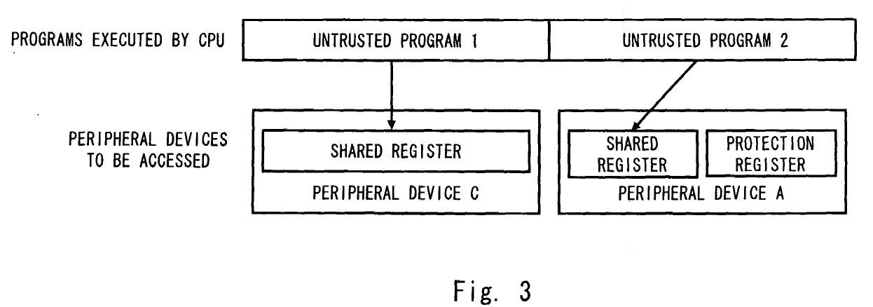

As described above, in the data processing apparatus 1 according to the first embodiment, the first address detection units and the second address detection units are provided in proportion to the number of the registers of each peripheral device. Accordingly, the access permission at each access authority level can be set for each register of the peripheral devices. FIG. 3 shows a timing diagram of an accessing operation of the data processing apparatus 1 to the peripheral device of this case. FIG. 3 shows an example in which the peripheral device C includes only the shared register and the peripheral device A includes both the shared register and the protection register. In this case, the data processing apparatus 1 can access the shared register of the peripheral device C during the execution of an untrusted program with the access authority level indicating the user level. Though the peripheral device A includes both the shared register and the protection register, the CPU 10 can access the shared register of the peripheral device A even when the CPU 10 executes the untrusted program with the access authority level indicating the user level. On the other hand, unless the CPU 10 executes a trusted program with the access authority level indicating the OS level, the CPU 10 cannot access the protection register of the peripheral device A.

As described above, in the data processing apparatus 1, the setting of access protection for each register enables the program with the low access authority level to access the register, the access to which is not restricted in the peripheral device. In this case, in the data processing apparatus 1, a target peripheral device can be accessed without switching programs with different access authority levels, which results in an increase in access rate.

When the conventional data processing apparatus that performs protection setting for each peripheral device uses peripheral devices to perform the same function for both the trusted program and the untrusted program without switching between the trusted program and the untrusted program, it is necessary to provide a plurality of peripheral devices having the same function. Accordingly, the conventional data processing apparatus has a problem of duplication of peripheral devices, for example, which leads to an increase in circuit size. On the other hand, in the data processing apparatus 1 of the first embodiment, the setting of the access protection for each register enables sharing of the peripheral device by the programs executed at different access authority levels. As a result, the data processing apparatus 1 enables a reduction in the number of peripheral devices, which leads to a reduction in circuit size.

Further, in the conventional data processing apparatus, when the access of the untrusted program to all the functions of the peripheral devices is permitted by placing greater importance on a system performance, it is impossible to prevent unauthorized access from the untrusted program. As a result, in this case, there arises a problem in that system security is considerably lowered. On the other hand, in the data processing apparatus 1 of the first embodiment, the peripheral device protection circuit 12 performs protection for the protection register, the access to which by the program executed at the low access authority level is to be restricted. Accordingly, the reliability for the protection register, the access to which is to be restricted, is not impaired.

### Second Embodiment

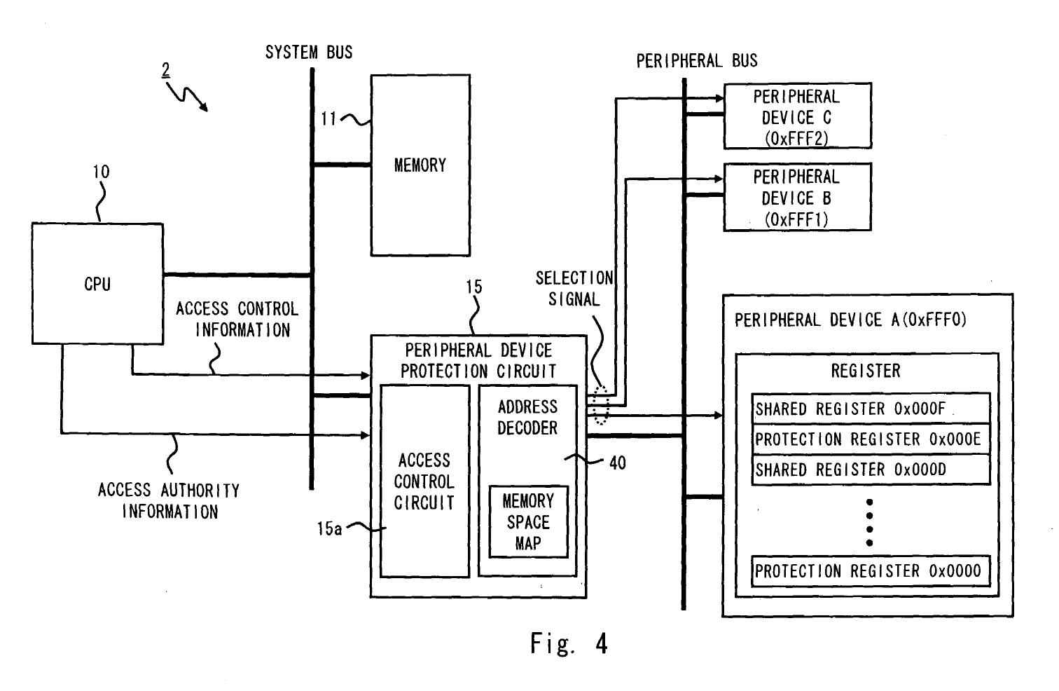

FIG. 4 shows a block diagram of a data processing apparatus 2 according to a second embodiment of the present invention. The data processing apparatus 2 according to the second embodiment shows a modified example of the peripheral device protection circuit 12 of the first embodiment. The data processing apparatus 2 includes a peripheral device protection circuit 15 as a modified example of the peripheral device protection circuit 12. It is assumed that the peripheral device protection circuit 15 outputs a single selection signal to a single peripheral device. The selection signal according to the second embodiment is enabled when the access is determined as permission in the peripheral device protection circuit 15, and is disabled when the access is determined as denial in the peripheral device protection circuit 15.

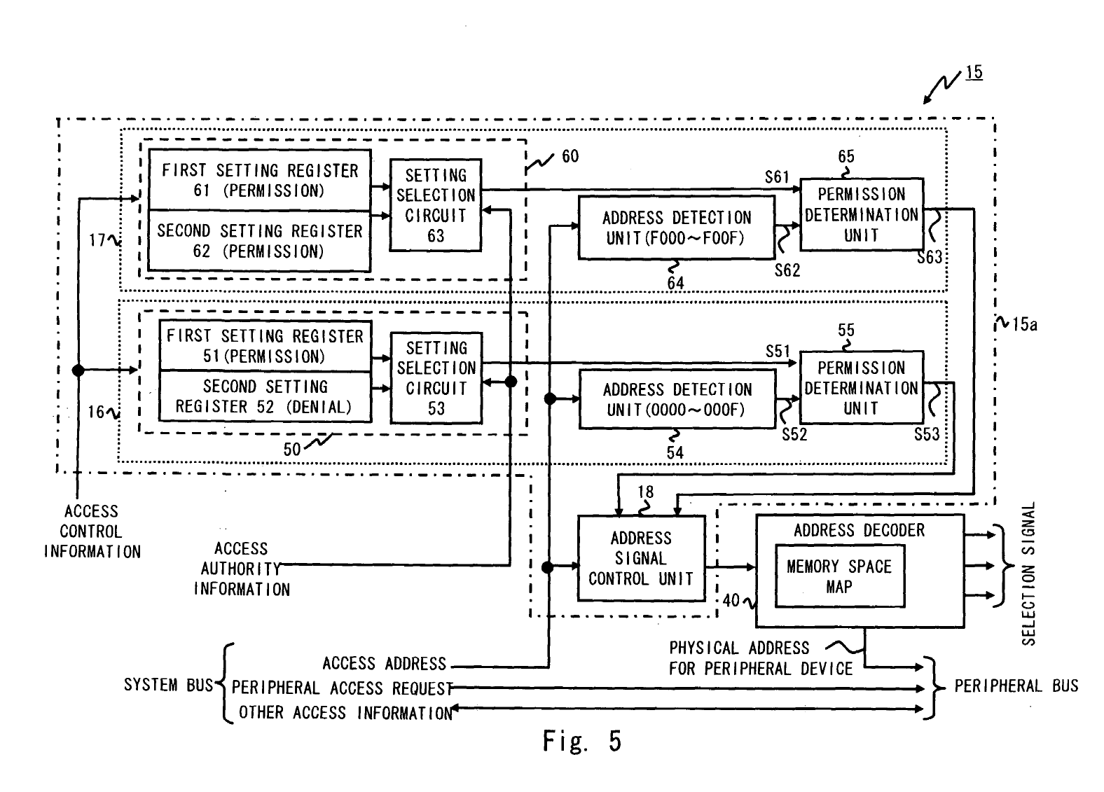

The peripheral device protection circuit 15 includes an access control circuit 15a and an address decoder 40. Note that the address decoder 40 of the second embodiment includes a memory space map. FIG. 5 shows a block diagram illustrating details of the peripheral device protection circuit 15. As shown in FIG. 5, the peripheral device protection circuit 15 includes a first access determination unit 16, a second access determination unit 17, an address signal control unit 18, and the address decoder 40.

The first access determination unit 16 includes a first access authority detection unit 50, a first address detection unit 54, and a first permission determination unit 55. The first access authority detection unit 50 outputs a permission determination signal S51 enabled when the access authority level indicates the OS level. The first access authority detection unit 50 includes a first setting register 51, a second setting register 52, and a setting selection circuit 53. The first setting register 51, the second setting register 52, and the setting selection circuit 53 of the first access authority detection unit 50 respectively correspond to the first setting register 21, the second setting register 22, and the setting selection circuit 23 of the first access authority detection unit 20 according to the first embodiment, so a description thereof is herein omitted.

The first address detection unit 54 is provided according to a range of access addresses corresponding to protection registers permitted to be accessed at the OS level. In the second embodiment, the range of the access addresses of the protection registers permitted to be accessed at the OS level is from 0x0000 to 0x000F (only addresses of registers). Thus, the first address detection unit 54 stores 0x0000 to 0x000F as the access address range. Then, when a part of each access address, which indicates a register address of each peripheral device, falls within the address range held in the first address detection unit 54, the first address detection unit 54 outputs a detection result signal S52.

The first permission determination unit 55 is provided to correspond to the first address detection unit 54. The first permission determination unit 55 is notified of the access authority information indicating the OS level by the permission determination signal S51 from the first access authority detection unit 50. When the access address contained in the address range held by the first address detection unit 54 is detected in the corresponding first address detection unit 54, the first permission determination unit 55 outputs a first enable signal S53.

The second access determination unit 17 includes a second access authority detection unit 60, a second address detection unit 64, and a second permission determination unit 65. The second access authority detection unit 60 outputs a permission determination signal S61 enabled when the access authority level is the user level or the OS level. The second access authority detection unit 60 includes a first setting register 61, a second setting register 62, and a setting selection circuit 63. The first setting register 61, the second setting register 62, and the setting selection circuit 63 of the second access authority detection unit 60 respectively correspond to the first setting register 31, second setting register 32, and the setting selection circuit 33 of the second access authority detection unit 30 of the first embodiment, so a description thereof is omitted.

The second address detection unit 64 is provided according to a range of access addresses corresponding to shared registers permitted at the user level. In the second embodiment, the range of the access addresses of the shared registers permitted to be accessed at the user level is from 0xF000 to 0xF00F (only addresses of registers). Thus, the second address detection unit 64 stores 0xF000 to 0xF00F as the access address range. Then, when a part of each access address, which indicates a register address of each peripheral device, falls within the address range held in the second address detection unit 64, the second address detection unit 64 outputs a detection result signal S62.

The second permission determination unit 65 is provided to correspond to the second address detection unit 64. The second permission determination unit 65 is notified of the access authority information indicating the user level or the OS level by the permission determination signal S61 from the second access authority detection unit 60. When the access address contained in the address range held by the second address detection unit 64 is detected in the corresponding second address detection unit 64, the second permission determination unit 65 outputs a second enable signal S63.

When at least one of the first enable signal S53 and the second enable signal S63 indicates the permission state, the address signal control unit 18 transfers the access address output by the CPU 10 to a post-stage of the address decoder 40.

The address decoder 40 includes the memory space map, and converts input access addresses into physical addresses of registers of each peripheral device according to the memory space map. Further, the address decoder 40 refers to a part of each access address, which indicates a peripheral device address. When the physical address corresponding to the access address is present on the memory space map, the address decoder 40 enables the selection signal for the corresponding peripheral device.

In the memory space map provided in the address decoder 40, a memory space for each peripheral device is defined by each access address, and the access addresses provided in the memory space are respectively associated with the physical addresses of the registers of each peripheral device. Further, the memory space map includes a first memory space map (peripheral device register map) corresponding to the first address range indicating the access addresses for the protection registers, and a second memory space map (for example, shared register map) corresponding to the second address range indicating the access addresses for the shared registers. In the second embodiment, the access authority corresponding to the protection register is set to all the registers provided in each peripheral device, and several shared registers are selected from among the registers provided in each peripheral device.

The memory space map according to the second embodiment includes the access addresses corresponding to all the registers in the peripheral device register map. The shared register map is obtained using a mapping of only physical address parts of the registers set as the shared registers in the peripheral device register map. In short, the access addresses defined by the second access range include access addresses that are not associated with physical addresses. Further, the memory space map according to the second embodiment forms the shared register map as a mapping of the peripheral device register map. In this case, the access address range of the shared register map is set to an address value having a predetermined offset value from the access address of the peripheral device register map. As a result, upon receiving the access address corresponding to the shared register map, the address decoder 40 can use a value obtained by subtracting the offset value from the access address as a physical address. The memory space map thus formed enables simplification of an operation for decoding, with the result that the address decoder 40 can be realized with a small circuit size.

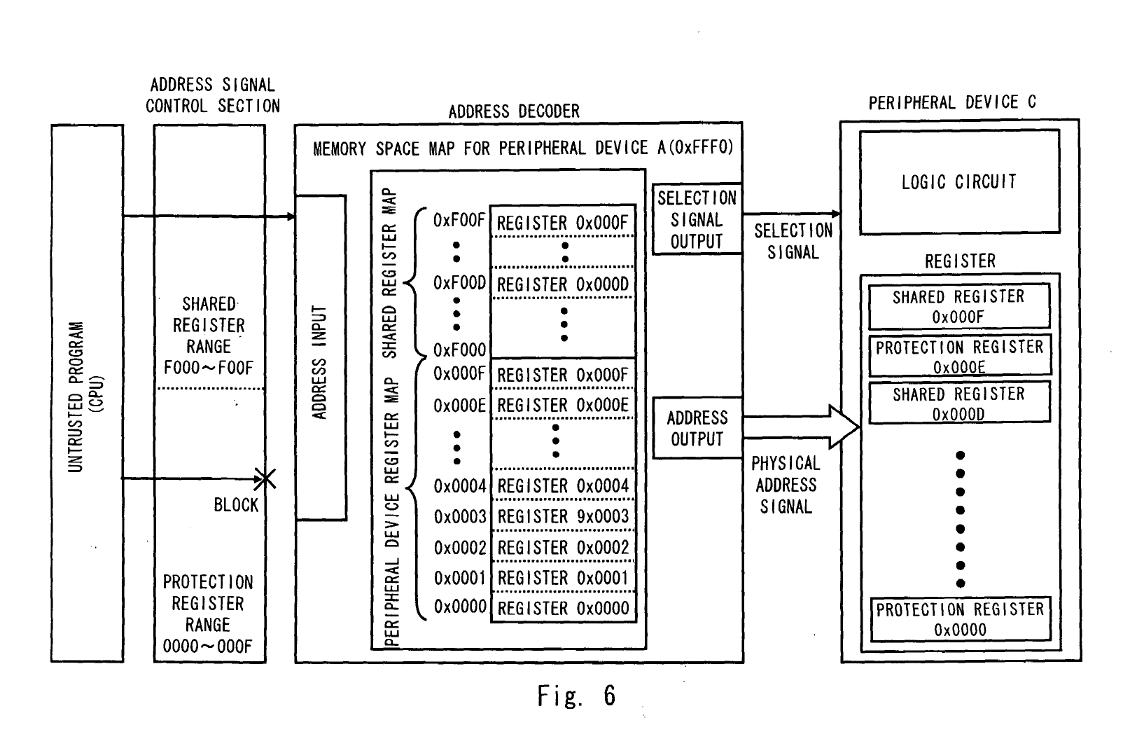

FIG. 6 shows a conceptual diagram illustrating a case of making access to the peripheral device via the address decoder 40 when the CPU 10 executes an untrusted program. The example shown in FIG. 6 illustrates the case where the CPU 10 executes the untrusted program. In this case, when the CPU 10 outputs an address contained in the first address range (for example, protection register range) as an access address, the address signal control unit 18 blocks the access address because both the first enable signal S53 and the second enable signal S63 are disabled. Meanwhile, when CPU 10 outputs an address contained in the second address range (for example, shared register range) as an access address, the address signal control unit 18 transfers the access address to the address decoder 40 because the second enable signal S63 is enabled.

Upon receiving the access address, the address decoder 40 refers to a part of the access address, which indicates a peripheral device address, and searches the memory space map for the peripheral device corresponding to the peripheral device address. Then, the address decoder 40 refers to a register address part of the access address. When the physical address corresponding to the referred register address is present, the address decoder 40 outputs the physical address as a physical address signal to the peripheral bus. Further, when the physical address corresponding to the access address is present, the address decoder 40 enables the selection signal for the peripheral device serving as an access target.

In the example shown in FIG. 6, when the CPU 10 outputs 0xFFF0_{—}0000 to 0xFFF0_{—}000F as access addresses during the execution of the untrusted program, the address signal control unit 18 blocks the access addresses. Meanwhile, when the CPU 10 outputs 0xFFF0_F000 to 0xFFF_F00 F as access addresses, the address signal control unit 18 transfers the access addresses to the address decoder 40. The address decoder 40 refers to the memory space map containing the input access addresses. In the second embodiment, if the access address is 0xFFF0_F00D or 0xFFF0_F00F, the physical addresses 0x000D and 0x000F corresponding to those access addresses are defined. Accordingly, if the access address is 0xFFF0_F00D or 0xFFF0_F00F, the address decoder 40 enables the selection signal for the peripheral device A, and outputs 0x000D or 0x000F as the physical address.

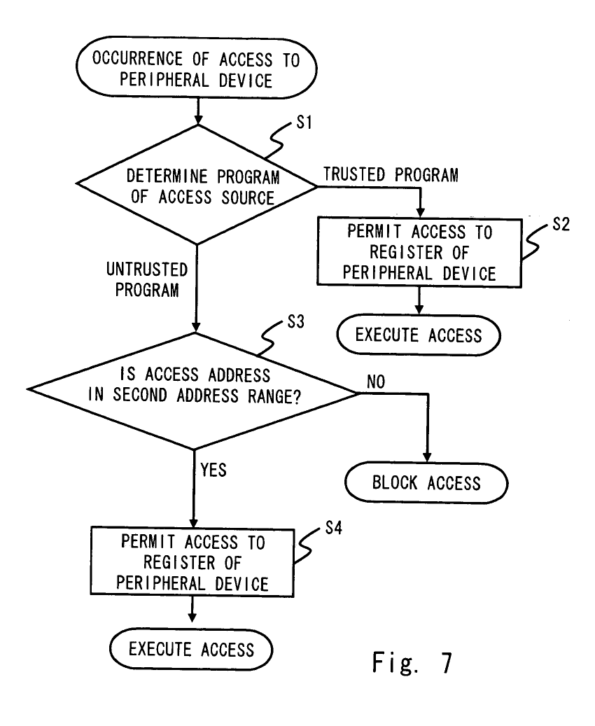

FIG. 7 shows a flowchart of an operation of the data processing apparatus 2. Referring to FIG. 7, the operation of the data processing apparatus 2 will be described. First, when access to the peripheral device occurs in the CPU 10, the program being executed by the CPU 10 serving as an access source is determined as a trusted program or an untrusted program (Step S1). The operation performed in Step S1 is a determination operation carried out in each of the first access authority detection unit 50 and the second access authority detection unit 60. When the CPU 10 executes the trusted program in Step S1, the access authority level indicates the OS level and the first access authority detection unit 50 outputs the permission determination signal S51. In the second embodiment, the trusted program is permitted to access all the registers of each peripheral device. Accordingly, the peripheral device protection circuit 15 sets the selection signal as the permission state to permit the access (Step S2).

On the other hand, when the CPU 10 executes the untrusted program in Step S1, the access authority level indicates the user level and the second access authority detection unit 60 outputs the permission determination signal S61. Then, it is determined whether the access address falls within the second address range (Step S3). When the access address falls outside the second address range, the access is blocked in the peripheral device protection circuit 15. Meanwhile, when the access address falls within the second address range, the access is permitted according to the memory space map (Step S4).

As described above, in the second embodiment, it is first determined whether the access address is valid for the access authority level in the access control circuit 15a. If it is determined that the access address is valid as a result of the determination, the address decoder 40 decodes the address. In this case, the address decoder 40 decodes access addresses for each register of the peripheral devices. Accordingly, the data processing apparatus 2 of the second embodiment is also capable of performing protection setting for each register of the peripheral devices.

Further, in the data processing apparatus 1, it is necessary to provide the address determination unit and the permission determination unit for each register. In the data processing apparatus 2, however, it is only necessary to determine the access address range at each access authority level, whereby the number of each of the address determination units and the permission determination units can be reduced compared with the data processing apparatus 1. Furthermore, since the data processing apparatus 2 includes the address decoder 40, there is no need to provide an address decoder for each peripheral device, which leads to a reduction in size of each peripheral device.

Furthermore, since the address decoder 40 defines the functions of the registers of each register, it is unnecessary to take into consideration of the functions of the registers of each peripheral device on the memory space map in the design of each peripheral device. In short, in the second embodiment, by updating the memory space map of the address decoder 40, attributes of the registers of each peripheral device can be set. Accordingly, the provision of the address decoder 40 enables simplification of the design of each peripheral device.

### Third Embodiment

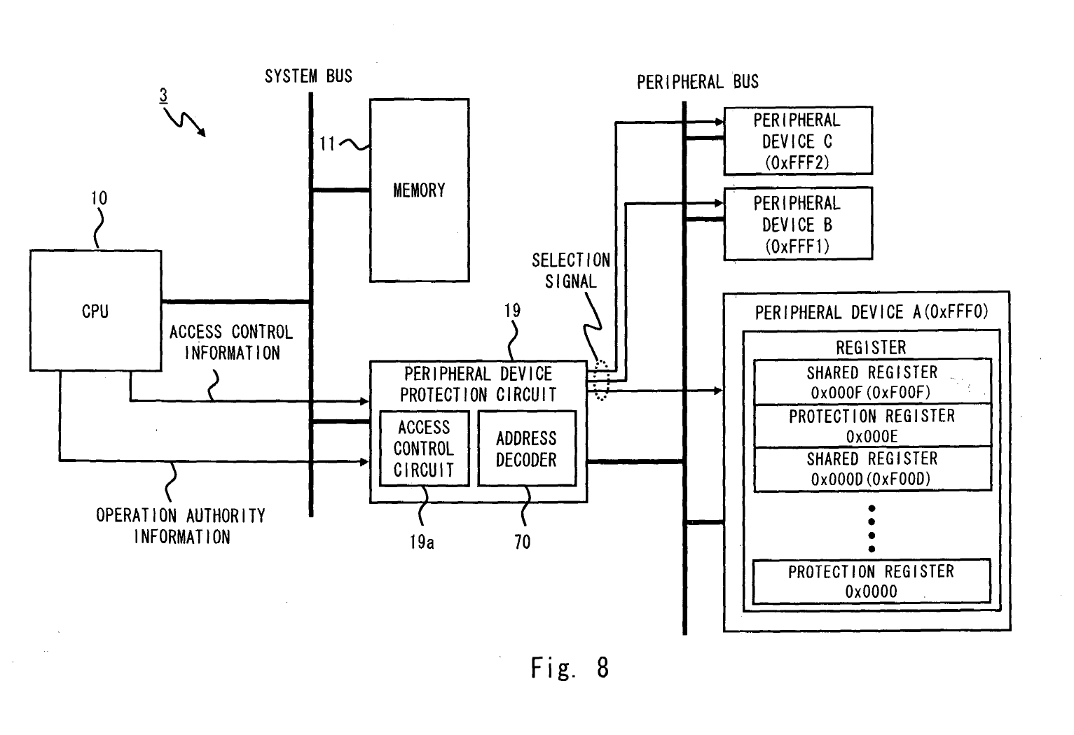

FIG. 8 shows a block diagram showing a data processing apparatus 3 according to a third embodiment of the present invention. The data processing apparatus 3 shows a modified example of the peripheral device protection circuit 12 of the data processing apparatus 1. The data processing apparatus 3 includes a peripheral device protection circuit 19 as a modified example of the peripheral device protection circuit 12. The peripheral device protection circuit 19 includes an access control circuit 19a and an address decoder 70.

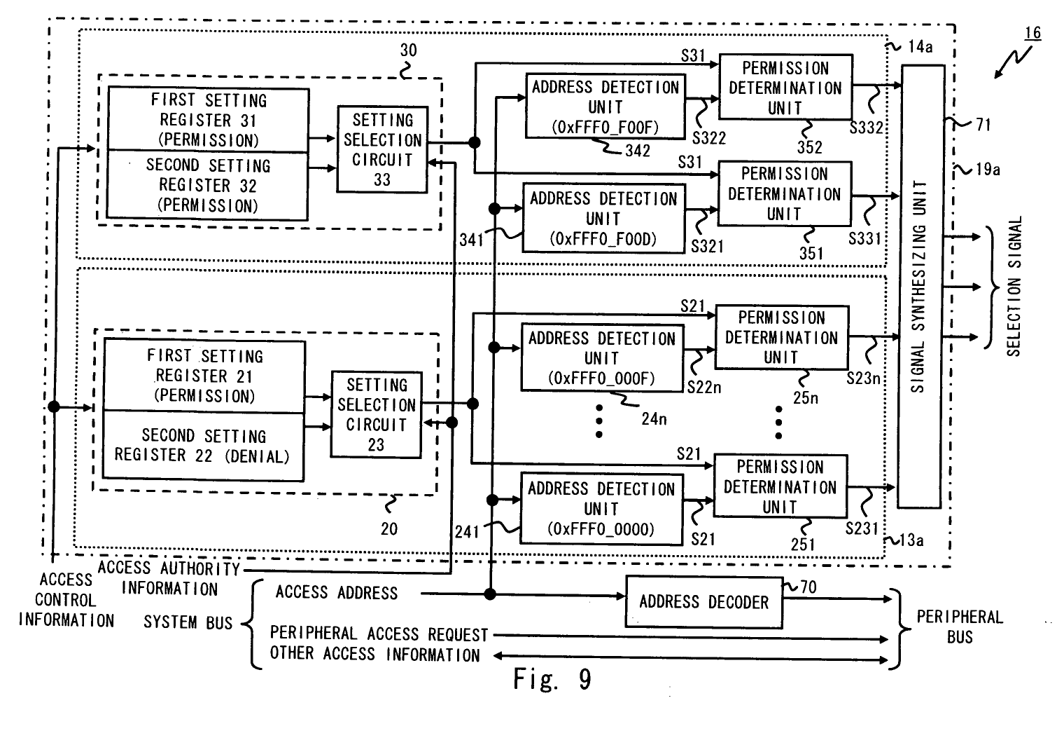

FIG. 9 shows a block diagram of the peripheral device protection circuit 19. As shown in FIG. 9, the access control circuit 19a is a modified example of the access control circuit 12a of the first embodiment, and includes a signal synthesizing unit 71 which is obtained by integrating the first signal synthesizing unit 26 and the second signal synthesizing unit 36 into one. Other parts of the access control circuit 19a are substantially the same as those of the access control circuit 12a, so a description thereof is herein omitted. Note that a selection signal output from the access control circuit 19a functions in a similar manner as the selection signal output from the address decoder 40 according to the second embodiment. Referring to FIG. 9, a first access determination unit 13a and a second access determination unit 14a correspond to the corresponding parts of the first access determination unit 13 and the second access determination unit 14, respectively, except for the signal synthesizing unit 71.

Further, the address decoder 70 is provided on a wire for transmitting access addresses among wires each connecting a system bus to a peripheral bus. The address decoder 70 according to the third embodiment does not include a memory space map. If the address decoder 70 not having the memory space map already exists, the existing address decoder 70 may be used. Also in this case, the access control circuit 19a outputs the selection signal, thereby enabling protection of the registers of each peripheral device.

As described above, according to the third embodiment, the provision of the address decoder 70 not having the memory space map enables a reduction in circuit area of each peripheral device. In this case, if the address decoder 70 already exists, the existing address decoder 70 may be used so as to reduce a time required for circuit design. Furthermore, also in the data processing apparatus 3 according to the third embodiment, the protection setting for each register of the peripheral devices can be performed by the access control circuit in the same manner as in the first embodiment.

### Fourth Embodiment

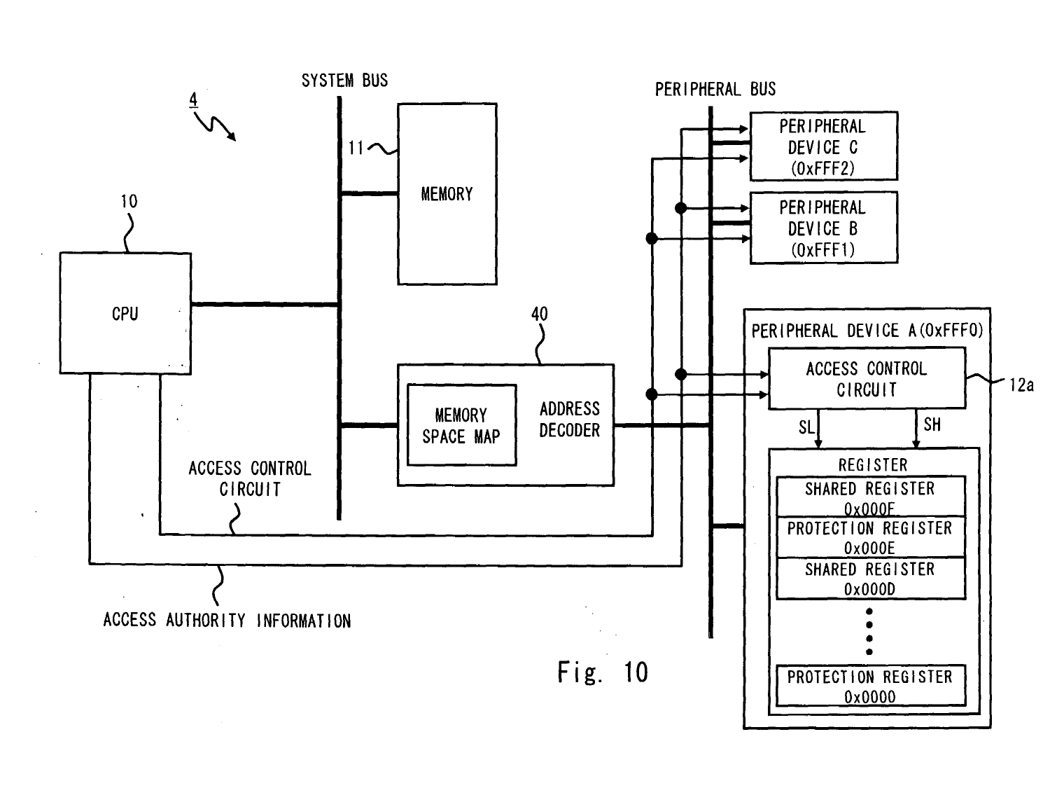

FIG. 10 shows a block diagram showing a data processing apparatus 4 according to a fourth embodiment of the present invention. The data processing apparatus 4 realizes access guard for each register by arranging blocks in a different manner from the data processing apparatuses of the above embodiments. Referring to FIG. 10, the data processing apparatus 4 includes the address decoder 40 of the second embodiment provided between a system bus and a peripheral bus. Further, each peripheral device of the data processing apparatus 4 includes the access control circuit 12a of the first embodiment.

Specifically, in the data processing apparatus 4, the address decoder 40 first performs decoding of addresses and generation of selection signals. Then, determination as to a relation between an access authority level and an access address is carried out on the peripheral device side. In short, also in the data processing apparatus 4, the protection setting for each register of the peripheral devices can be performed in a similar manner as in the above embodiments.

It is apparent that the present invention is not limited to the above embodiments, but may be modified and changed without departing from the scope and spirit of the invention. For example, an address translation rule for the address decoder can be arbitrarily set depending on the operation of the system.

What is claimed is:

1. A data processing apparatus, comprising:
peripheral devices each including a plurality of registers;
a processing unit to output access authority information indicative of one of a first access authority level and a second access authority level according to a program to be executed, the second access authority level being an access authority level lower than the first access authority level, and to output an access address to specify a specific register among the plurality of registers; and
a peripheral device protection circuit connected to the processing unit and receiving the access authority information and the access address so as to control access of the processing unit to the peripheral devices,
wherein the peripheral device protection circuit controls whether to permit the access to the specific register specified by the access address, based on the access authority level indicated by the access authority information.

2. The data processing apparatus according to claim 1, wherein the peripheral device protection circuit determines whether to permit the access to the specific register, and outputs a selection signal to instruct each of the peripheral devices to enable/disable the access to the specific register based on a result of the determination.

3. The data processing apparatus according to claim 2, wherein the peripheral devices each allow the specific register to be accessed by the processing unit when the selection signal indicates that the access of the processing unit is valid.

4. The data processing apparatus according to claim 1, wherein the peripheral device protection circuit includes an access control circuit, the access control circuit including:
a first access determination unit to output a first access permission signal in a case where the access address input when the access authority information indicates the first access authority level shows an address of each of registers permitted to be accessed at the first access authority level; and
a second access determination unit to output a second access permission signal in a case where the access address input when the access authority information indicates the second access authority level shows an address of each of registers permitted to be accessed at the second access authority level.

5. The data processing apparatus according to claim 4, wherein:
the first access determination unit includes:
a plurality of first address detection units provided to correspond to the plurality of registers, respectively, to detect corresponding access addresses;
a plurality of first permission determination units provided to correspond to the plurality of first address detection units, respectively, to output a first enable signal when the access address is detected in any of the plurality of first address detection units when the access authority information indicates the first access authority level; and
a first signal synthesizing unit to output a first selection signal indicating that the access to each of the registers to be permitted at the first access authority level is enabled, in response to the plurality of first enable signals; and
the second access determination unit includes:
a plurality of second address detection units provided to correspond to the registers permitted to be accessed at the second access authority level, respectively, among the plurality of registers, to detect corresponding access addresses;
a plurality of second permission determination units provided to correspond to the plurality of second address detection units, respectively, to output a second enable signal when the access address is detected in any of the plurality of second address detection units when the access authority information indicates the second access authority level; and
a second signal synthesizing unit to output a second selection signal indicating that the access to each of the registers to be permitted at the second access authority level is enabled, in response to the plurality of second enable signals.

6. The processing apparatus according to claim 4, wherein:
the first access determination unit includes:
a first address detection unit to detect the access address contained in a first address range indicating a range of the access addresses of the registers permitted to be accessed at the first access authority level, from among the access addresses; and
a first permission determination unit provided to correspond to the first address detection unit so as to output a first enable signal when the access address is detected in the first address detection unit in the case where the access authority information indicates the first access authority level;
the second access determination unit includes:
a second address detection unit to detect the access address contained in a second address range indicating a range of the access addresses of the registers permitted to be accessed at the second access authority level, from among the access addresses; and
a second permission determination unit provided to correspond to the second address detection unit so as to output a second enable signal when the access address is detected in the second address detection unit in the case where the access authority information indicates the second access authority level; and
the access control circuit includes:
an address signal control unit to output the access address to a post-stage circuit when one of the first enable signal and the second enable signal indicates a permission state.

7. The data processing apparatus according to claim 3, wherein the peripheral device protection circuit includes an address decoder to decode the access addresses to output physical addresses of the plurality of registers.

8. The data processing apparatus according to claim 7, wherein the address decoder includes:
a first memory space map associating the access addresses output by the processing unit at the first access authority level and contained in the first address range, with the physical addresses of the plurality of registers; and
a second memory space map associating the access addresses output by the processing unit at the second access authority level and contained in the second address range, with the physical addresses of the registers permitted to be accessed at the second access authority level among the plurality of registers.

9. The data processing apparatus according to claim 8, wherein, when physical addresses associated with second access addresses defined by the second address range are identical with physical addresses associated with first access addresses defined by the first address range, a difference between values of the addresses is defined to have a predetermined offset value.

10. The data processing apparatus according to claim 8, wherein the address decoder outputs the selection signal to each of the peripheral device corresponding to the access address when the access address is contained in one of the first access range and the second access range and when a physical address associated with the access address is present.

11. The data processing apparatus according to claim 10, wherein:
the peripheral device protection circuit includes the access control circuit provided for each of the peripheral devices; and
the peripheral device protection circuit includes the address decoder provided at a pre-stage of the access control circuit.

12. The data processing apparatus according to claim 1, wherein the plurality of registers each store a preset value to specify an operating state of each of the peripheral devices.

13. The data processing apparatus according to claim 1, wherein the plurality of registers each store data to be processed by each of the peripheral devices.

14. An access control method for a data processing apparatus, the data processing apparatus comprising:
peripheral devices each including a plurality of registers;
a processing unit to output access authority information indicative of one of a first access authority level and a second access authority level according to a program to be executed, the second access authority level being an access authority level lower than the first access authority level, and to output an access address to specify a specific register among the plurality of registers; and
a peripheral device protection circuit connected to the processing unit and receiving the access authority information and the access address so as to control access of the processing unit to the peripheral devices, the method comprising:
determining whether to permit access to the specific register specified by the access address, based on the access authority level indicated by the access authority information; and
controlling the access to the specific register based on a result of the determination.

15. The access control method for a data processing apparatus according to claim 14, further comprising determining, by the peripheral device protection circuit, whether to permit the access to the specific register, and outputting a selection signal to instruct each of the peripheral devices to enable/disable the access to the specific register based on a result of the determination.

16. The access control method for a data processing apparatus according to claim 15, wherein the peripheral devices each allow the specific register to be accessed by the processing unit when the selection signal indicates that the access of the processing unit is valid.

17. The access control method for a data processing apparatus according to claim 14, further comprising:
outputting, by the peripheral device protection circuit, a first access permission signal in a case where the access address input when the access authority information indicates the first access authority level shows an address of each of registers permitted to be accessed at the first access authority level;
outputting, by the peripheral device protection circuit, a second access permission signal in a case where the access address input when the access authority information indicates the second access authority level shows an address of each of registers permitted to be accessed at the second access authority level; and
controlling, by the peripheral device protection circuit, the access to the specific register according to a state of each of the first access permission signal and the second access permission signal.

18. The access control method for a data processing apparatus according to claim 14, wherein the plurality of registers each store a preset value to specify an operating state of each of the peripheral devices.

19. The access control method for a data processing apparatus according to claim 14, wherein the plurality of registers each store data to be processed by each of the peripheral devices.
